(19) United States
(12) Patent Application Publication
(10) Pub. No.: US 2024/0037449 A1
(43) Pub. Date: Feb. 1, 2024

(54) TEACHING DEVICE, TEACHING METHOD, AND COMPUTER PROGRAM PRODUCT

(71) Applicant: KABUSHIKI KAISHA TOSHIBA, Tokyo (JP)

(72) Inventors: Osamu YAMAGUCHI, Yokohama (JP); Mieko ASANO, Kawasaki (JP); Yojiro TONOUCHI, Inagi (JP)

(73) Assignee: KABUSHIKI KAISHA TOSHIBA, Tokyo (JP)

(21) Appl. No.: 18/173,202

(22) Filed: Feb. 23, 2023

(30) Foreign Application Priority Data
Jul. 27, 2022 (JP) 2022-119512

(51) Int. Cl. G06N 20/00

(52) U.S. Cl. CPC G06N 20/00

(57) ABSTRACT

According to an embodiment, a teaching device includes: an acquisition unit configured to acquire first input data; an estimation unit configured to estimate a first estimation result from the first input data, using a machine learning model; a search unit configured to search for a second taught estimation result taught for second input data, the second taught estimation result being associated with at least one of the second input data similar to the first input data, and a second estimation result similar to the first estimation result and estimated from the second input data, using the machine learning model; and a selection unit configured to select one selection candidate among a plurality of selection candidates including the first estimation result and the second taught estimation result, as a correction target estimation result to be used for correction of the first estimation result.

### CROSS-REFERENCE TO RELATED APPLICATIONS

This application is based upon and claims the benefit of priority from Japanese Patent Application No. 2022-119512, filed on Jul. 27, 2022; the entire contents of which are incorporated herein by reference.

### FIELD

Embodiments described herein relate generally to a teaching device, a teaching method, and a computer program product.

### BACKGROUND

In recent years, estimation results have been obtained from input data using a machine learning model. In order to realize excellent performance of the machine learning model, it is necessary to prepare a large amount of teaching data including a pair of learning data and correct answer data. Therefore, a technique for easily obtaining the teaching data used for learning of the machine learning model is disclosed. For example, JP2021-96748A discloses a technique for searching for another region on a medical image similar to a region designated by a user on the medical image, and using the searched the other region as teaching data for machine learning.

However, in a case where a machine learning model is applied to an environment different from that at the time of learning, when input data used in the environment is input to the machine learning model, an estimation result with low accuracy may be output. Therefore, the user corrects the estimation result output from the machine learning model so as to obtain an estimation result of a correct answer, and uses the corrected estimation result as new teaching data. However, in the related art, the estimation result output from the machine learning model is used as it is as a correction target, and as such, a correction load by the user may increase as the estimation result with low accuracy is output.

### BRIEF DESCRIPTION OF THE DRAWINGS

FIG. 1 is a block diagram of a teaching system;

FIG. 2A is a schematic diagram of first input data;

FIG. 2B is a schematic diagram of a first estimation result;

FIG. 2C is a schematic diagram of a first correct answer estimation result;

FIG. 3 is a schematic diagram illustrating a data configuration of a correction example DB;

FIG. 4 is an explanatory diagram of search processing by a search unit;

FIG. 5 is an explanatory diagram of selection processing by a selection unit;

FIG. 6 is a schematic diagram of a correction target estimation result;

FIG. 7 is a schematic diagram of a first taught estimation result;

FIG. 8 is an explanatory diagram of a correction method of the related art;

FIG. 9 is a flowchart illustrating a flow of information processing;

FIG. 10 is a block diagram of the teaching system;

FIG. 11A is a schematic diagram of the first input data;

FIG. 11B is a schematic diagram of the first estimation result;

FIG. 12 is a schematic diagram of the first estimation result;

FIG. 13 is a schematic diagram of a second taught estimation result;

FIG. 14A is an explanatory diagram of generation of a candidate estimation result;

FIG. 14B is an explanatory diagram of generation of the candidate estimation result;

FIG. 15 is an explanatory diagram of selection processing;

FIG. 16A is an explanatory diagram of acquisition processing of the first input data;

FIG. 16B is a schematic diagram of the first estimation result;

FIG. 16C is an explanatory diagram of the correction target estimation result;

FIG. 16D is a schematic diagram of the first taught estimation result;

FIG. 17A is an explanatory diagram of processing by a conversion unit;

FIG. 17B is an explanatory diagram of processing by the conversion unit;

FIG. 18 is a flowchart illustrating a flow of the information processing; and

FIG. 19 is a hardware configuration diagram.

### DETAILED DESCRIPTION

According to an embodiment, a teaching device includes an acquisition unit, an estimation unit, a search unit, and a selection unit. The acquisition unit is configured to acquire first input data. The estimation unit is configured to estimate a first estimation result from the first input data, using a machine learning model. The search unit is configured to search for a second taught estimation result taught for second input data. The second taught estimation result is associated with at least one of the second input data similar to the first input data, and a second estimation result similar to the first estimation result and estimated from the second input data, using the machine learning model. The selection unit is configured to select one selection candidate among a plurality of selection candidates including the first estimation result and the second taught estimation result, as a correction target estimation result to be used for correction of the first estimation result.

Hereinafter, a teaching device, a teaching method, and a computer program product will be described in detail with reference to the accompanying drawings.

### First Embodiment

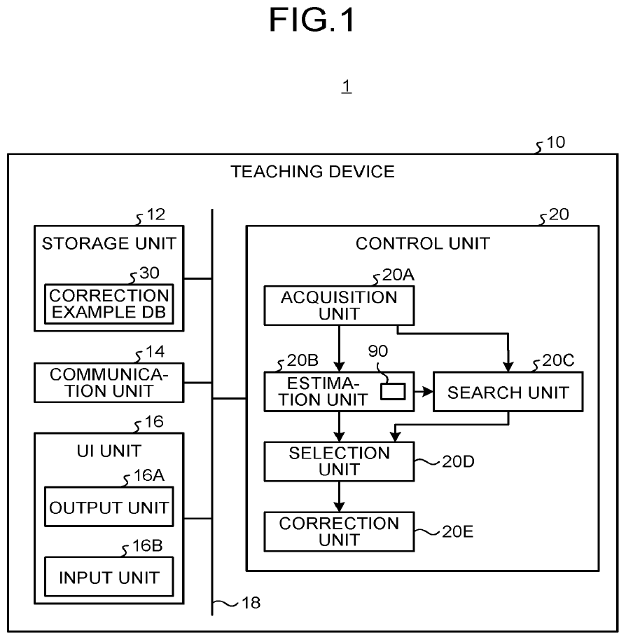

FIG. 1 is a block diagram illustrating an example of a configuration of a teaching system 1 according to the present embodiment.

The teaching system 1 includes a teaching device 10.

The teaching device 10 is an information processing device configured to teach teaching data used for learning of a machine learning model 90. The teaching of the teaching data indicates association of correct answer information with respect to input data, and the information is referred to as a label. Therefore, the teaching of the teaching data may be referred to as labeling, annotation, or the like.

The teaching device 10 includes a storage unit 12, a communication unit 14, a user interface (UI) unit 16, and a control unit 20. The storage unit 12, the communication unit 14, the UI unit 16, and the control unit 20 are communicably connected to each other via a bus 18 or the like.

The storage unit 12 stores various types of information. For example, a correction example database (DB) 30 is stored in the storage unit 12 in advance. Details of data configuration of the correction example DB 30 will be described later.

The communication unit 14 is a communication interface configured to communicate with an external information processing device outside the teaching device 10. For example, the communication unit 14 communicates with the external information processing device or an electronic device by a wired network such as Ethernet (registered trademark), a wireless network such as wireless fidelity (Wi-Fi) or Bluetooth (registered trademark), or the like.

The UI unit 16 includes an output unit 16A and an input unit 16B. The output unit 16A outputs various types of information. The output unit 16A is, for example, a display unit which is a display, a speaker, a projection device, or the like. In the present embodiment, a description will be given as to a mode, as an example, in which the output unit 16A is the display unit. The input unit 16B receives an operation instruction from a user. The input unit 16B is, for example, a pointing device such as a mouse and a touch pad, a keyboard, or the like. The UI unit 16 may be a touch panel in which the output unit 16A and the input unit 16B are configured to be integrated with each other.

The control unit 20 executes information processing in the teaching device 10. The control unit 20 includes an acquisition unit 20A, an estimation unit 20B, a search unit 20C, a selection unit 20D, and a correction unit 20E.

The acquisition unit 20A, the estimation unit the search unit 20C, the selection unit 20D, and the correction unit 20E are implemented by, for example, one or more processors. For example, each of the above-described units may be implemented by causing a processor such as a central processing unit (CPU) to execute a program, that is, by software. Each of the units may be implemented by a processor such as a dedicated IC, that is, by hardware. Each of the units may be implemented by using software and hardware in combination. In the case of using a plurality of processors, each processor may implement one of the respective units, or may implement two or more of the respective units.

It is noted that at least one of the units included in the control unit 20 may be configured to be mounted on the external information processing device communicably connected to the teaching device 10 via a network or the like. Furthermore, at least one of the various types of information stored in the storage unit 12 may be stored in an external storage device communicably connected to the teaching device 10 via a network or the like. Furthermore, at least one of the storage unit 12 and the UI unit 16 may be configured to be mounted on the external information processing device communicably connected to the teaching device 10.

The acquisition unit 20A acquires first input data. The first input data is an example of input data. In the present embodiment, the input data acquired by the acquisition unit 20A is referred to as the first input data.

The input data is data to be input to the machine learning model 90. A data format of the input data is not limited. For example, the input data is image data, sound data, computer aided design (CAD) data consisting of symbol sequence, or the like.

In the present embodiment, a case in which the input data is the image data will be described as an example.

For example, the acquisition unit 20A acquires the first input data by reading the input data stored in the storage unit 12. The acquisition unit 20A may acquire the first input data by reading or receiving the input data from the external information processing device via the communication unit 14.

It is noted that, in a case where the input data is the sound data or the CAD data, the acquisition unit 20A may convert the CAD data or the sound data into image data, and use it as the first input data and second input data to be described later.

For example, the acquisition unit 20A converts the sound data into the image data by imaging power spectrum of the sound data. Furthermore, for example, the acquisition unit 20A converts the CAD data into the image data by rendering the CAD data. It is noted that the sound data and the CAD data may be retained in their original format are and used for processing. Specific examples will be described later.

The estimation unit 20B estimates a first estimation result from the first input data acquired by the acquisition unit 20A using the machine learning model 90.

The machine learning model 90 is a model configured to receive the input data and to output an estimation result of the input data. The estimation result is, for example, a classification result for each region by class separation or classification, a regression result of prediction or analysis, or the like. The classification result may be referred to as allocation of a label indicating correct answer information.

In a case where the input data is the image data, the classification result is represented by, for example, expressing regions by class separation with different colors for each class, or approximation by a polygon. Furthermore, in a case of representing an object detection result of a target by classification, the classification result is represented by a rectangular region surrounding the target, a bitmap that is a point set representing a polygon or a region of the outline of the target, or the like.

In a case where the input data is the sound data, the classification result is represented by, for example, a label representing interval information, phonemes, words, and the like for the sound and acoustic information. In a case where the input data is the CAD data, the classification result is represented by, for example, a label representing structure information, attribute information, and the like with respect to the CAD data as primitive.

A machine learning method of the machine learning model 90 is not limited. As the machine learning model 90, for example, a model using a known machine learning method such as convolutional neural network (CNN), random forest, or support vector machine (SVM) may be used.

In the present embodiment, a description will be given as to a mode, as an example, in which the machine learning model 90 is a model configured to use a deep learning network or the like that performs semantic segmentation and to output an estimation result of a target region included in the input data that is the image data. An example of the machine learning model 90 includes a model such as a fully convolutional network (FCN) configured to perform semantic segmentation by an architecture including only a convolution layer and a pooling layer. Furthermore, examples of the machine learning model 90 include an architecture including an encoder and a decoder, such as SegNet, and a model using U-Net which is a U-shaped network.

The estimation unit 20B inputs the first input data acquired by the acquisition unit 20A to the machine learning model 90, thereby obtaining the first estimation result as an output from the machine learning model 90.

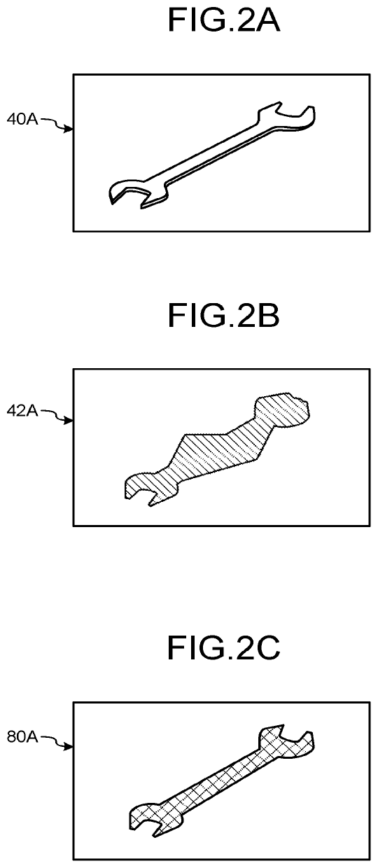

FIG. 2A is a schematic diagram of an example of first input data 40A. FIG. 2B is a schematic diagram of an example of a first estimation result 42A. FIG. 2C is a schematic diagram of an example of a first correct answer estimation result 80A.

For example, it is assumed that the estimation unit 20B inputs the first input data 40A illustrated in FIG. 2A to the machine learning model 90 to estimate the first estimation result 42A illustrated in FIG. 2B as an estimation result of the first input data 40A. On the other hand, it is assumed that an estimation result of a correct answer of the first input data 40A is the first correct answer estimation result 80A illustrated in FIG. 2C.

As described above, the first estimation result 42A estimated by the machine learning model 90 may represent a result different from the first correct answer estimation result 80A, which is the estimation result of the correct answer.

Referring back to FIG. 1, the description will be continued. Therefore, the teaching device 10 according to the present embodiment includes the search unit 20C, the selection unit 20D, the correction unit 20E, and the like.

The search unit 20C searches for a second taught estimation result taught for second input data, and associated with at least one of the second input data similar to the first input data 40A and a second estimation result similar to the first estimation result 42A.

The second input data is an example of the input data. The second input data is input data which is input to the machine learning model 90 earlier than the first input data and are already associated with the second estimation result, which is the estimation result from the machine learning model 90, and the second taught estimation result.

The second estimation result is an estimation result estimated from the second input data using the machine learning model 90. The second taught estimation result is a corrected estimation result obtained by correcting the second estimation result to be a taught estimation result of the correct answer.

The search unit 20C searches for the second taught estimation result satisfying the above conditions from the correction example DB 30.

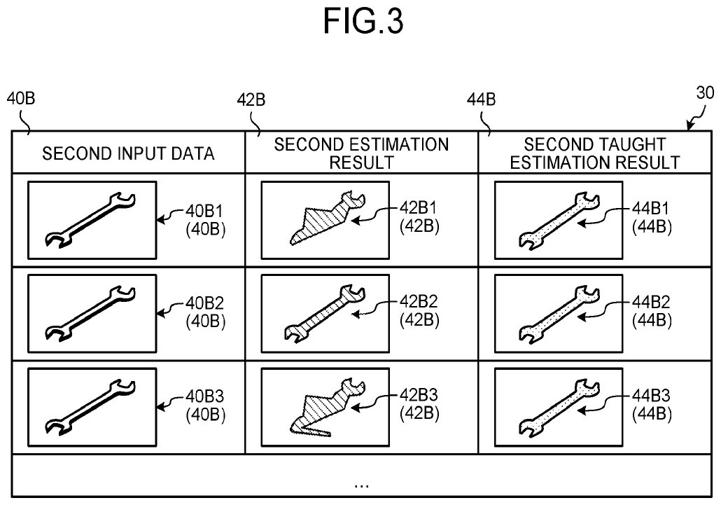

FIG. 3 is a schematic diagram illustrating an example of a data configuration of the correction example DB 30. The correction example DB 30 is a database in which second input data 40B, a second estimation result 42B, and a second taught estimation result 44B are associated with each other. A data format of the correction example DB 30 is not limited to the database. For example, the data format of the correction example DB 30 may be a table.

FIG. 3 illustrates, as an example, a state in which second input data 40B1 to second input data 40B3 are registered as the second input data 40B. Additionally, FIG. 3 illustrates, as an example, a state in which second estimation results 42B1 to 42B3 are associated with each other and registered as the second estimation results 42B corresponding to the second input data 40B1 to 40B3, respectively. Additionally, FIG. 3 illustrates, as an example, a state in which second taught estimation results 44B1 to 44B3 are associated with each other and registered as the second taught estimation results 44B corresponding to the second input data 40B1 to 40B3, respectively.

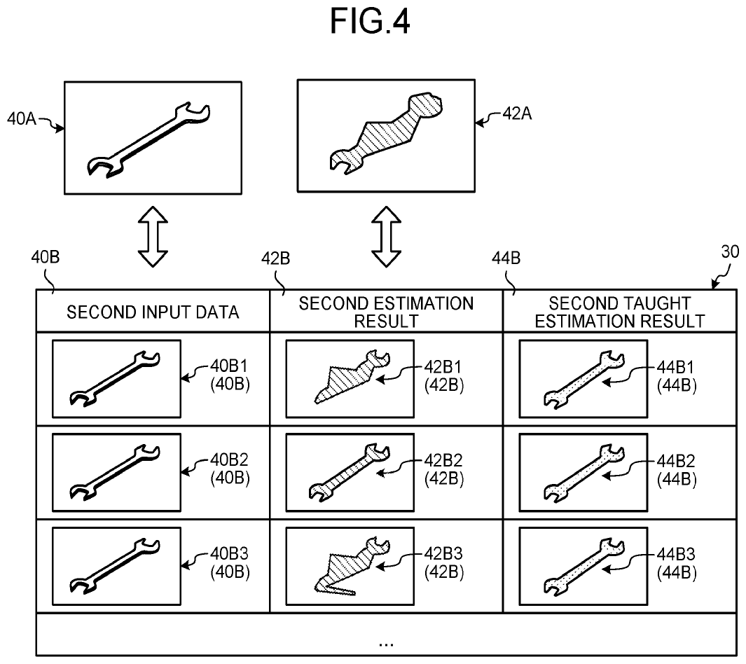

FIG. 4 is an explanatory diagram of an example of search processing by the search unit 20C.

The search unit 20C extracts one or more pieces of second input data 40B similar to the first input data among the plurality of pieces of second input data 40B registered in the correction example DB 30 from the correction example DB 30.

The search unit 20C may specify the second input data 40B having a similarity to the first input data 40A equal to or greater than a predetermined first threshold value. In addition, the search unit 20C may specify a predetermined number of pieces of second input data 40B in descending order of similarity. The first threshold value and the predetermined number may be appropriately changeable depending on an operation instruction or the like of the input unit 16B by the user.

In addition, the search unit 20C specifies one or more second estimation results 42B similar to the first estimation result 42A among the plurality of second estimation results 42B registered in the correction example DB 30 from the correction example DB 30.

The search unit 20C may specify the second estimation result 42B having a similarity to the first estimation result 42A equal to or greater than a predetermined second threshold value. In addition, the search unit 20C may specify a predetermined number of second estimation results 42B in descending order of similarity. The second threshold value and the predetermined number may be appropriately changeable depending on the operation instruction or the like of the input unit 16B by the user.

Then, the search unit 20C searches the correction example DB 30 for the second taught estimation result 44B associated with at least one of the second input data 40B similar to the first input data 40A and the second estimation result 42B similar to the first estimation result 42A.

Through the above-described search processing, the search unit 20C searches for the second taught estimation result 44B associated with at least one of the second input data 40B and the second estimation result 42B similar to at least one of the first input data 40A and the first estimation result 42A. It is noted that the search unit 20C may search for the second taught estimation result 44B satisfying the conditions, may search for one second taught estimation result 44B, or may search for a plurality of second taught estimation results 44B.

Referring back to FIG. 1, the description will be continued.

The selection unit 20D selects one selection candidate among a plurality of selection candidates including the first estimation result 42A and the second taught estimation result 44B as the correction target estimation result to be used for correction of the first estimation result 42A.

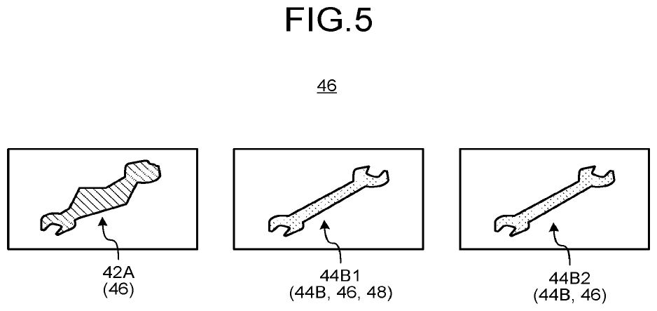

FIG. 5 is an explanatory diagram of an example of selection processing by the selection unit 20D. For example, it is assumed that the first estimation result 42A is estimated by the estimation unit 20B, and the second taught estimation results 44B1 and 44B2 are searched by the search unit 20C.

In this case, the selection unit 20D acquires, as a selection candidate 46, each of the first estimation result 42A estimated from the first input data 40A, and the second taught estimation results 44B1 and 44B2 searched by the search unit 20C.

It is noted that the selection unit 20D may acquire the second taught estimation results 44B1 and 44B2 searched by the search unit 20C as the selection candidate 46, and may exclude the first estimation result 42A estimated by the estimation unit 20B from the selection candidate 46.

Then, the selection unit 20D selects one selection candidate 46 among the plurality of selection candidates 46 as a correction target estimation result 48 used for correction of the first estimation result 42A.

For example, the selection unit 20D outputs a list of the plurality of acquired selection candidates 46 to the output unit 16A. At this time, the selection unit 20D may also output, to the output unit 16A, at least one of the first input data 40A and the second input data 40B respectively corresponding to the selection candidates 46 and the second estimation result 42B.

The user operates the input unit 16B while visually recognizing the output unit 16A as the display unit, thereby selecting and inputting one selection candidate 46 to be used for correction of the estimation result for the first input data 40A as the correction target estimation result 48.

The selection unit 20D selects, as the correction target estimation result 48, one selection candidate 46 for which the selection input by the user is received, among the plurality of selection candidates 46 output to the output unit 16A. FIG. 5 illustrates a case, as an example, where the second taught estimation result 44B1 is selected as the correction target estimation result 48.

Furthermore, the selection unit 20D may automatically select, as the correction target estimation result 48, one selection candidate 46 satisfying a predetermined condition among the plurality of acquired selection candidates 46.

The predetermined condition is, for example, one second taught estimation result 44B associated with the second input data 40B most similar to the first input data among the one or more second taught estimation results 44B included in the selection candidate 46. In this case, the selection unit 20D selects, as the correction target estimation result 48, the selection candidate 46, which is one second taught estimation result 44B associated with the second input data 40B most similar to the first input data among the plurality of acquired selection candidates 46. The similarity may be appropriately set. For example, an image may be input to a machine learning model or a network for obtaining a normalized cross-correlation value used for image matching or an image feature amount, and similarity between respective image feature amounts may be used.

Furthermore, the predetermined condition is, for example, one second taught estimation result 44B associated with the second estimation result 42B most similar or most dissimilar to the first estimation result 42A among the one or more second taught estimation results 44B included in the selection candidate 46. In this case, the selection unit 20D selects, as the correction target estimation result 48, one second taught estimation result 44B associated with the second estimation result 42B most similar or most dissimilar to the first estimation result 42A among the plurality of acquired selection candidates 46.

In addition, the predetermined condition is, for example, one second taught estimation result 44B associated with a pair of the second input data 40B and the second estimation result 42B most similar to a pair of the first input data 40A and the first estimation result 42A among the one or more second taught estimation results 44B included in the selection candidate 46. In this case, the selection unit 20D selects, as the correction target estimation result 48, one second taught estimation result 44B associated with the pair of the second input data 40B and the second estimation result 42B most similar to the pair of the first input data 40A and the first estimation result 42A among the plurality of acquired selection candidates 46. For the similarity of each pair, in the same manner as in the above description, for example, an image may be input to a machine learning model or a network for obtaining a normalized cross-correlation value used for image matching or an image feature amount, and similarity between respective image feature amounts may be used.

Furthermore, the predetermined condition is, for example, the second taught estimation result 44B most similar or most dissimilar to the first estimation result 42A among the one or more second taught estimation results 44B included in the selection candidate 46. In this case, the selection unit 20D selects, as the correction target estimation result 48, one second taught estimation result 44B most similar or most dissimilar to the first estimation result 42A among the plurality of acquired selection candidates 46.

Furthermore, the predetermined condition may be, for example, one random selection candidate 46. In this case, the selection unit 20D selects one selection candidate 46 randomly selected among the plurality of acquired selection candidates 46 as the correction target estimation result 48.

Referring back to FIG. 1, the description will be continued.

The correction unit 20E receives a correction input by the user with respect to the correction target estimation result 48, and generates a first taught estimation result 44A taught for the first input data 40A, the first taught estimation result 44A being obtained by reflecting the received correction input in the correction target estimation result 48.

The correction unit 20E receives the correction target estimation result 48, which is one selection candidate 46 selected by the selection unit 20D, from the selection unit 20D. Then, the correction unit 20E outputs the correction target estimation result 48 received from the selection unit 20D to the output unit 16A.

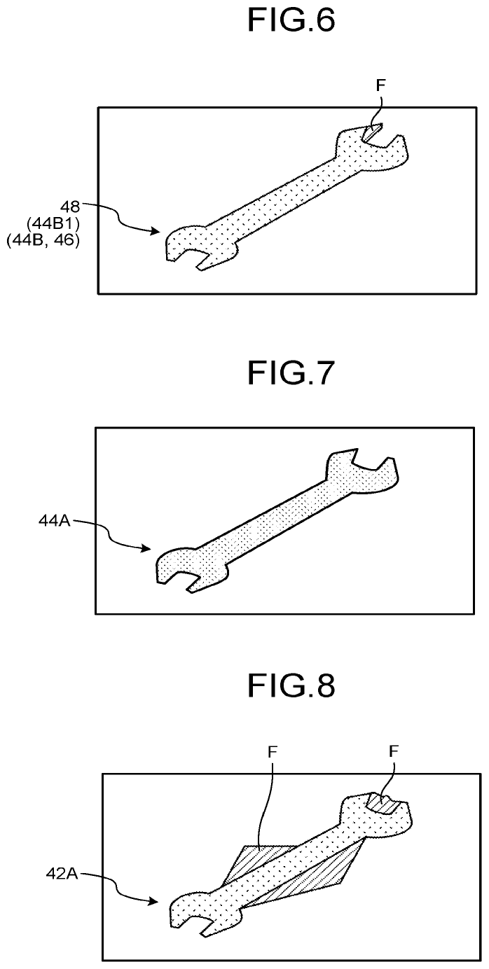

FIG. 6 is a schematic diagram of an example of the correction target estimation result 48. FIG. 6 illustrates, as an example, a case where the second taught estimation result 44B1, which is one of the plurality of selection candidates 46, is output to the output unit 16A as the correction target estimation result 48.

The user corrects a correction region F in the correction target estimation result 48 by operating the input unit 16B while visually recognizing the output to the output unit 16A, that is, the correction target estimation result 48 displayed on the display unit. For example, the user corrects the correction region F in the correction target estimation result 48 by performing an operation of filling a region of the correction target for the correction target estimation result 48 by operating the input unit 16B. The correction region F is represented by, for example, a pixel region including one or more pixels. These corrections may be deletion of an excess regions as well as addition of a missing region for the correct answer region.

The correction unit 20E reflects the correction region F, which is the correction input input by the operation instruction of the input unit 16B by the user, in the second taught estimation result 44B1, which is the correction target estimation result 48, thereby generating the first taught estimation result.

FIG. 7 is a schematic diagram of an example of the first taught estimation result 44A. FIG. 7 illustrates, as an example, the first taught estimation result 44A generated by reflecting the correction region F for the correction target estimation result 48 illustrated in FIG. 6.

Here, in the related art, the user performs correction using the first estimation result 42A by the machine learning model 90 of the first input data 40A as it is as a correction target.

FIG. 8 is an explanatory diagram of an example of a correction method of the related art. For example, the user performs an operation input of the correction region F on the first estimation result 42A by the machine learning model 90 of the first input data 40A.

On the other hand, in the teaching device 10 according to the present embodiment, one selection candidate 46 selected by the selection unit 20D from the plurality of selection candidates 46 is used as the correction target estimation result 48. Therefore, as illustrated in FIG. 6, the user can generate the first taught estimation result 44A with a smaller correction amount than the range of the correction region F of the related art illustrated in FIG. 8.

Referring back to FIG. 1, the description will be continued.

The correction unit 20E stores the first input data 40A acquired by the acquisition unit 20A, the first estimation result 42A estimated from the first input data using the machine learning model 90, and the first taught estimation result 44A generated by the correction unit 20E in the correction example DB 30 in association with each other as each of the second input data 40B, the second estimation result 42B, and the second taught estimation result 44B.

That is, the input data as the first input data and the second input data 40B, the estimation result by the machine learning model 90, and the corrected, that is, the taught estimation result, the teaching of which is completed, are registered and updated in the correction example DB 30 in association with each other.

Therefore, in the teaching device 10 or the external information processing device, a plurality of pieces of teaching data in which the second input data 40B registered in the correction example DB 30 is used as the learning data and the second taught estimation result 44B is used as the correct answer data can be used for relearning of the machine learning model 90. Furthermore, by using the teaching data, the teaching device 10 according to the present embodiment can reduce the load of relearning of the machine learning model 90.

Here, it is assumed that the machine learning model 90 does not exist in the estimation unit 20B. For example, in a case where teaching of a completely new target is performed, the machine learning model 90 does not exist in the estimation unit 20B. In this case, when the acquisition unit 20A acquires the first input data 40A, the control unit 20 receives an operation input of the UI unit 16 by the user, thereby acquiring the first taught estimation result 44A manually created by the user for the first input data 40A. Then, the control unit 20 registers the first input data 40A and the created first taught estimation result 44A in the correction example DB 30 in association with each other as the second input data 40B and the second taught estimation result 44B. When the acquisition unit 20A newly acquires the first input data the control unit 20 may use, as the initial value, the second taught estimation result 44B associated with the second input data 40B similar to the newly acquired first input data 40A.

By executing the above-described processing, the teaching device 10 according to the present embodiment can improve efficiency of teaching even when the machine learning model 90 does not exist in the estimation unit 20B.

Next, an example of a flow of information processing executed by the teaching device 10 according to the present embodiment will be described.

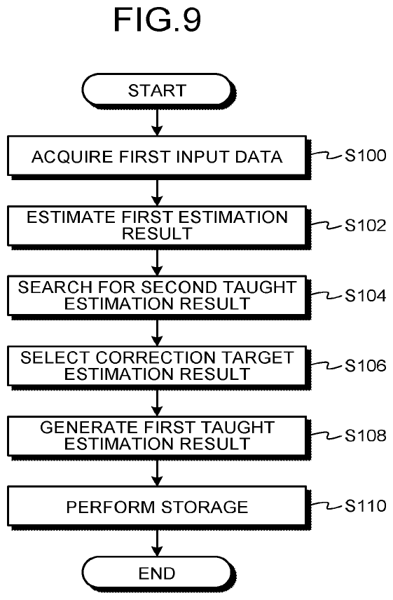

FIG. 9 is a flowchart illustrating the example of the flow of the information processing executed by the teaching device 10 according to the present embodiment.

The acquisition unit 20A acquires the first input data 40A (Step S100). The estimation unit 20B estimates the first estimation result 42A from the first input data 40A acquired in Step S100 using the machine learning model (Step S102).

The search unit 20C searches for the second taught estimation result 44B associated with at least one of the second input data similar to the first input data 40A acquired in Step S100 and the second estimation result similar to the first estimation result 42A estimated in Step S102 (Step S104).

The selection unit 20D selects, as the correction target estimation result 48, the plurality of selection candidates 46 including the first estimation result 42A estimated in Step S102 and the second taught estimation result 44B searched in Step S104 (Step S106).

The correction unit 20E receives a correction input by the user for the correction target estimation result 48 selected in Step S106, and generates the first taught estimation result 44A taught for the first input data 40A, the first taught estimation result 44A being obtained by reflecting the received correction input in the correction target estimation result 48 (Step S108).

The correction unit 20E stores the first input data 40A acquired in Step S100, the first estimation result 42A estimated in Step S102, and the first taught estimation result 44A generated in Step S108 in the correction example DB 30 in association with each other as the second input data 40B, the second estimation result 42B, and the second taught estimation result 44B (Step S110).

Then, this routine is ended.

As described above, the teaching device 10 according to the present embodiment includes the acquisition unit 20A, the estimation unit 20B, the search unit 20C, and the selection unit 20D. The acquisition unit acquires the first input data 40A. The estimation unit estimates the first estimation result 42A from the first input data 40A using the machine learning model 90. The search unit 20C searches for the second taught estimation result 44B taught for the second input data 40B, and associated with at least one of the second input data similar to the first input data 40A and the second estimation result 42B similar to the first estimation result 42A and estimated from the second input data 40B using the machine learning model 90. The selection unit selects one selection candidate 46 among the plurality of selection candidates 46 including the first estimation result 42A and the second taught estimation result 44B as the correction target estimation result 48 to be used for correction of the first estimation result 42A.

As described above, the teaching device 10 according to the present embodiment selects, as the correction target estimation result 48, one of the plurality of selection candidates 46 including the second taught estimation result 44B associated with at least one of the second input data 40B similar to the first input data 40A and the second estimation result 42B similar to the first estimation result 42A, and the first estimation result 42A.

Therefore, the teaching device 10 according to the present embodiment can select, as the correction target estimation result 48, the selection candidate 46 having a high possibility of having a small correction amount for matching with the first correct answer estimation result as compared with the related art using the first estimation result 42A as it is as the correction target estimation result 48.

Therefore, the teaching device 10 according to the present embodiment can reduce the correction load of the output from the machine learning model 90.

In addition, the search unit 20C of the teaching device 10 according to the present embodiment searches for the second taught estimation result 44B taught for the second input data 40B, and associated with at least one of the second input data 40B similar to the first input data and the second estimation result 42B similar to the first estimation result 42A and estimated from the second input data 40B using the machine learning model 90. Therefore, the teaching device 10 according to the present embodiment can efficiently search for the selection candidate 46 having a higher possibility of having a smaller correction amount as the selection candidate 46 to become a candidate to be selected as the correction target estimation result 48.

It is noted that the present embodiment has been described assuming a case where the estimation unit 20B estimates the first estimation result 42A from the first input data 40A using one machine learning model 90. However, the estimation unit 20B may estimate the plurality of first estimation results 42A from one piece of first input data 40A using the plurality of machine learning models 90.

In this case, the estimation unit 20B estimates the plurality of first estimation results 42A by inputting the first input data 40A acquired by the acquisition unit 20A to each of the plurality of machine learning models 90. Then, the search unit 20C may search for the second taught estimation result 44B associated with at least one of the second input data 40B similar to the first input data 40A and the second estimation result 42B similar to each of the plurality of first estimation results 42A estimated by the estimation unit 20B.

Then, in the same manner as in the above description, the selection unit 20D may select one selection candidate 46 among the plurality of selection candidates 46 including the first estimation result 42A and the second taught estimation result 44B as the correction target estimation result 48 used for correction of the first estimation result 42A.

### Second Embodiment

In the present embodiment, a description will be given as to a mode in which a correction target estimation result is further selected from a plurality of types of selection candidates 46. In the present embodiment, the same reference numerals are given to the same configurations as those of the above embodiment, and a detailed description thereof will be omitted.

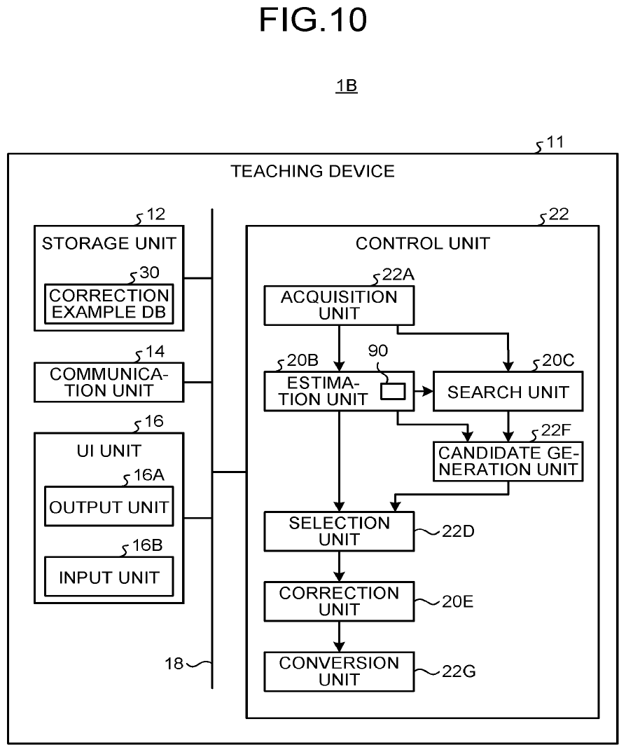

FIG. 10 is a block diagram illustrating an example of a configuration of a teaching system 1B according to the present embodiment.

The teaching system 1B includes a teaching device 11.

The teaching device 11 is similar to the teaching device 10 according to the above embodiment except that a control unit 22 is provided instead of the control unit 20. Specifically, the teaching device 11 includes the storage unit 12, the communication unit 14, the UI unit 16, and the control unit 22. The storage unit 12, the communication unit 14, the UI unit 16, and the control unit 22 are communicably connected to each other via the bus 18 or the like. The storage unit 12, the communication unit 14, and the UI unit 16 are similar to those in the above embodiment.

The control unit 22 executes information processing in the teaching device 11. The control unit 22 includes an acquisition unit 22A, the estimation unit 20B, the search unit 20C, a selection unit 22D, the correction unit 20E, a candidate generation unit 22F, and a conversion unit 22G. The control unit 22 is similar to the control unit 20 of the above embodiment except that the acquisition unit 22A is provided instead of the acquisition unit 20A, the selection unit 22D is provided instead of the selection unit 20D, and the candidate generation unit 22F and the conversion unit 22G are further provided.

The acquisition unit 22A acquires first input data in the same manner as that of the acquisition unit 20A according to the above embodiment.

In the present embodiment, the acquisition unit 22A further executes interpretation processing of interpreting the content of the first input data. Specifically, the acquisition unit 22A analyzes the first input data and acquires one or more pieces of element information included in the first input data. The element information is information indicating each element included in the input data such as the first input data and second input data. The element information is, for example, a name of an element such as a component included in the input data, a position of the element in the input data, and the like.

First, a description will be given, as an example, as to a case where the first input data and the second input data are image data.

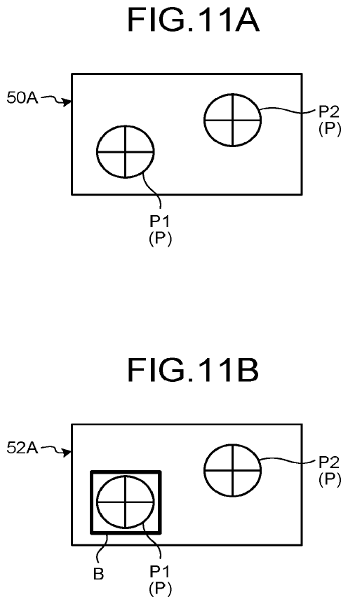

FIG. 11A is a schematic diagram illustrating an example of first input data 50A. FIG. 11A illustrates, as an example, a case where the acquisition unit 22A acquires the first input data 50A instead of the first input data 40A. FIG. 11A illustrates, as an example, a case where the first input data 50A is the image data.

The first input data 50A includes, for example, one or more target objects P. FIG. 11A illustrates, as an example, a case where the first input data 50A includes an object P1 and an object P2 as the target object P.

The target object P is a target to be estimated for an estimation result by the machine learning model 90. Here, a description will be given, as an example, as to a case where the machine learning model 90 is a model configured to output the position and range of the target object P included in the input data as the estimation result.

In the same manner as in the above embodiment, the estimation unit 20B estimates a first estimation result from the first input data 50A acquired by the acquisition unit 22A using the machine learning model 90.

FIG. 11B is a schematic diagram of an example of a first estimation result 52A. In the drawings after FIG. 11B, a rectangular frame B indicates the target object P, the position and range of which are estimated by the machine learning model 90.

For example, it is assumed that the estimation unit 20B inputs the first input data 50A illustrated in FIG. 11A to the machine learning model 90 to estimate the first estimation result 52A illustrated in FIG. 11B as an estimation result of the first input data 50A. The first input data 50A includes two target objects P of the object P1 and the object P2, but the first estimation result 52A includes only the position and range of the object P1, and the position and range of the object P2 are not estimated. Therefore, it is necessary for a user to correct the first estimation result 52A.

Referring back to FIG. 10, the description will be continued. In the same manner as in the above embodiment, the search unit 20C searches the correction example DB 30 for the second taught estimation result taught for the second input data, and associated with at least one of the second input data similar to the first input data 50A and the second estimation result similar to the first estimation result 52A. It is noted that, in this case, it is assumed that the second estimation result using the machine learning model 90, which is a model configured to output the position and range of the target object P included in the input data as the estimation result, and the second input data and the second taught estimation result corresponding to the second estimation result are registered in the correction example DB 30 in advance in association with each other.

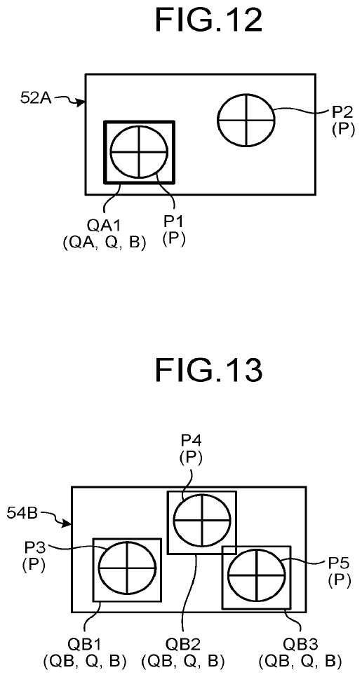

FIG. 12 is a schematic diagram of an example of the first estimation result 52A. FIG. 13 is a schematic diagram of an example of a second taught estimation result 54B. The search unit 20C searches for the second taught estimation result 54B illustrated in FIG. 13, for example, by performing search processing in the same manner as in the above embodiment. The second taught estimation result 54B is an example of a corrected second taught estimation result for second input data 50B. FIG. 13 illustrates an example in which the second input data 50B includes three target objects P of objects P1 to P3, and the second taught estimation result 54B corresponding to the second input data 50B includes an estimation result of the position and range of each of the target objects P1 to P3.

Referring back to FIG. 10, the description will be continued.

The candidate generation unit 22F generates one or more candidate estimation results different from the first estimation result 52A and the second taught estimation result 54B based on at least one of the first estimation result 52A and the second taught estimation result 54B.

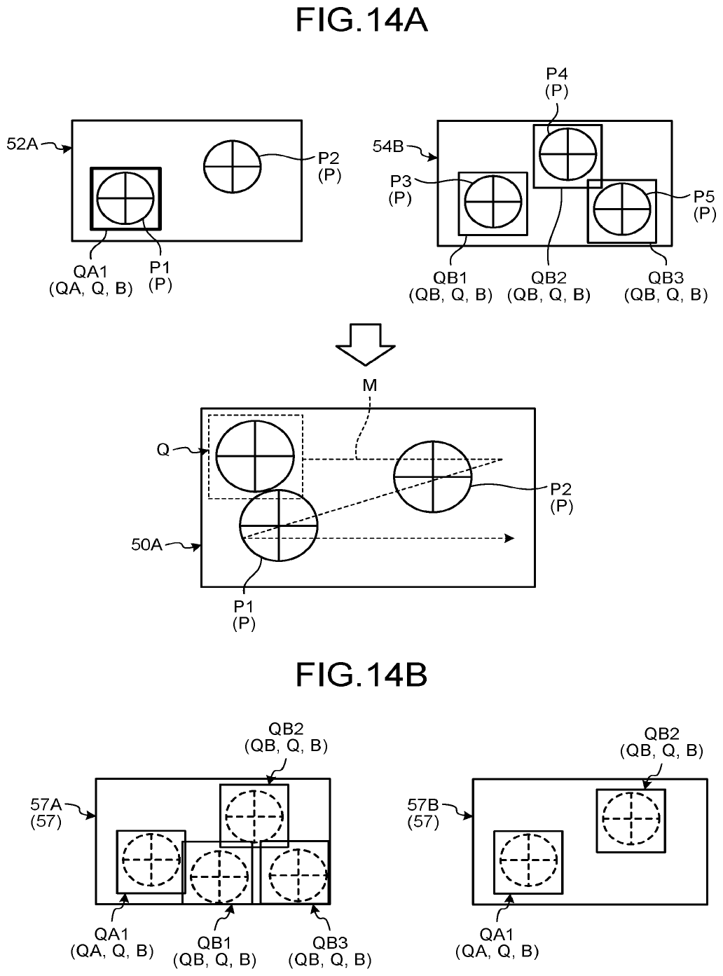

FIGS. 14A and 14B are explanatory diagrams of examples of generation of a candidate estimation result 57.

For example, the candidate generation unit 22F generates one or more candidate estimation results 57 including one or more local regions Q according to a matching degree between each of first local regions Q1 which are one or more local regions Q included in the first estimation result 52A for the first input data 50A, and each of second local regions Q2 which are one or more local regions Q included in the second taught estimation result 54B.

The local region Q means a local area of a part of each of the first estimation result 52A and the second taught estimation result 54B. Specifically, the local region Q means a portion in which the position and range of the target object P, which is the estimation result by the machine learning model 90, included in each of the first estimation result 52A and the second taught estimation result 54B are estimated.

Specifically, for example, the local region Q is a region including the target object P, the position and range of which are estimated as illustrated in FIGS. 14A and 14B.

The candidate generation unit 22F specifies a first local region QA1, which is the first local region Q1 included in the first estimation result 52A, and second local regions QB1 to QB3, which are the second local regions Q2 included in the second taught estimation result 54B.

Then, the candidate generation unit 22F uses each local region Q of the specified first local region Q1 and the second local regions QB1 to QB3 as a template, and determines whether the local region Q is similar to any region of the first input data 50A by template matching (refer to an arrow M in FIG. 14A).

Then, the candidate estimation result 57 including the local region Q determined to be similar is generated.

In addition, the candidate generation unit 22F changes a similarity threshold value used at the time of template matching, and performs template matching for each of a plurality of different threshold values. Then, the candidate generation unit 22F generates the candidate estimation result 57 including the local region Q determined to be similar for each template matching with the plurality of similarities having different threshold values.

Therefore, the candidate generation unit 22F generates a plurality of types of candidate estimation results 57 according to the similarity threshold values.

For example, as illustrated in FIG. 14B, the candidate generation unit 22F performs template matching with a low similarity threshold value to generate a candidate estimation result 57A including the first local region QA1 and the second local regions QB1 to QB3. In addition, the candidate generation unit 22F performs template matching with a high similarity threshold value to generate the candidate estimation result 57 including the first local region QA1 and the second local region QB2.

It is noted that the candidate generation unit 22F may generate one or three or more types of candidate estimation results 57 by adjusting the similarity threshold value.

Through the above-described processing, the candidate generation unit 22F generates the one or more candidate estimation results 57 including at least one local region Q included in the first estimation result 52A and the second taught estimation result 54B. In other words, the candidate generation unit 22F generates one or more candidate estimation results 57 obtained by changing the combination of one or more local regions Q included in the first estimation result 52A and the second taught estimation result 54B, and combining them.

Referring back to FIG. 10, the description will be continued.

The selection unit 22D selects one selection candidate among a plurality of selection candidates including the first estimation result 42A, the second taught estimation result 44B, and the candidate estimation result 57 as a correction target estimation result to be used for correction of the first estimation result 52A. That is, the selection unit 22D further uses the candidate estimation result 57 as a selection candidate in addition to the first estimation result 42A and the second taught estimation result 44B.

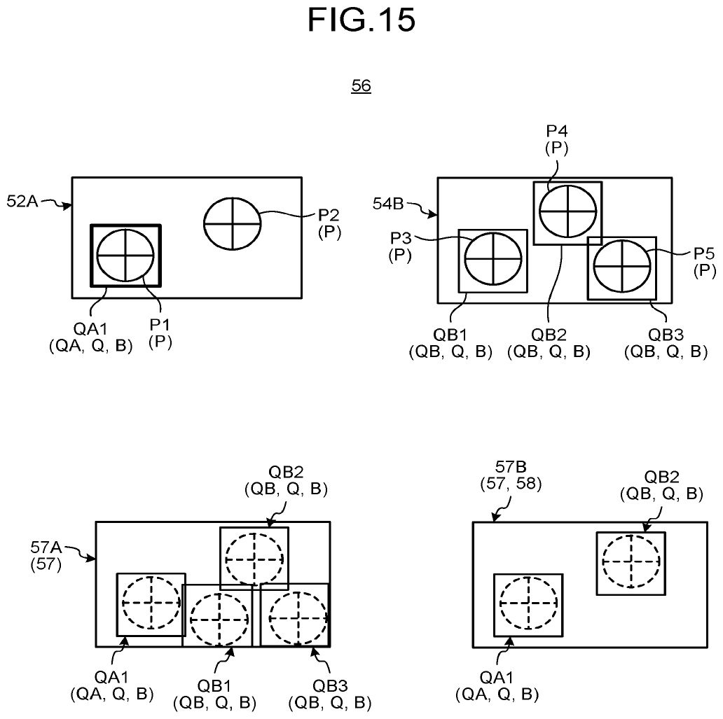

FIG. 15 is an explanatory diagram of an example of selection processing by the selection unit 22D. For example, it is assumed that the first estimation result 52A is estimated by the estimation unit 20B and the second taught estimation result 54B is searched by the search unit 20C. In addition, it is assumed that the candidate estimation result 57 including the candidate estimation result 57A and a candidate estimation result 57B is generated by the candidate generation unit 22F.

In this case, the selection unit 22D acquires, as a selection candidate 56, each of the first estimation result 52A estimated from the first input data 50A, the second taught estimation result 54B searched by the search unit 20C, and the candidate estimation results 57A and 57B generated by the candidate generation unit 22F.

Then, the selection unit 22D selects one selection candidate 56 among the plurality of selection candidates 56 as a correction target estimation result 58 used for correction of the first estimation result 52A.

In the same manner as that of the selection unit the selection unit 22D outputs a list of the selection candidates 56 to the output unit 16A, and selects one selection candidate 56 for which the selection input by the user is received, as the correction target estimation result 58. FIG. 15 illustrates, as an example, a case where the candidate estimation result 57B is selected as the correction target estimation result 58.

In the same manner as that of the selection unit the selection unit 22D may select one selection candidate 56 satisfying a predetermined condition among the plurality of selection candidates 56 as the correction target estimation result 48.

The predetermined condition is the same as in the first embodiment. For example, the predetermined condition in the present embodiment is the second taught estimation result 54B or the candidate estimation result 57 that is the most similar or the most dissimilar to the first estimation result 52A among the selection candidates 56.

Furthermore, the predetermined condition in the present embodiment may be, for example, one random selection candidate 56. In this case, the selection unit 22D selects one selection candidate 56 randomly selected among the plurality of acquired selection candidates 56 as the correction target estimation result 58.

Referring back to FIG. 10, the description will be continued.

The correction unit 20E is the same as in the above embodiment. The correction unit 20E receives a correction input by the user for the correction target estimation result 58 selected by the selection unit 22D, and generates the first taught estimation result 44A taught for the first input data 40A, the first taught estimation result 44A being obtained by reflecting the received correction input in the correction target estimation result 48.

The correction unit 20E receives the correction target estimation result 58, which is one selection candidate 56 selected by the selection unit 20D, from the selection unit 22D. Then, the correction unit 20E outputs the correction target estimation result 58 received from the selection unit 22D to the output unit 16A.

Then, the correction unit 20E reflects the correction input input by the operation instruction of the input unit 16B by the user in the correction target estimation result 58 to generate the first taught estimation result.

As described above, in the teaching device 11 according to the present embodiment, one selection candidate 56 further selected by the selection unit 22D from the plurality of selection candidates 56 is used as the correction target estimation result 58 as compared with the above embodiment. Therefore, the user can generate the first taught estimation result with a much smaller correction load as compared with the related art.

Next, a description will be given, as an example, as to a case where the input data is CAD data.

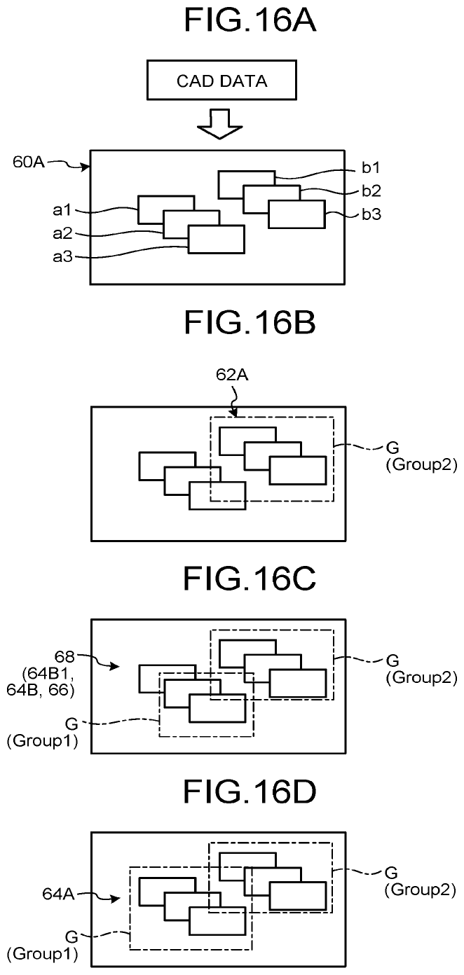

FIG. 16A is an explanatory diagram of an example of acquisition processing of first input data 60A by the acquisition unit 22A.

When acquiring the CAD data as the input data, the acquisition unit 22A converts the CAD data into image data and uses the image data as the first input data 60A. Since a method of converting the CAD data into the image data is described in the above embodiment, a description thereof is omitted here.

In addition, the acquisition unit 22A analyzes the first input data 60A and acquires one or more pieces of element information included in the first input data 60A. Specifically, for example, the acquisition unit 22A analyzes the CAD data, which is the input data before conversion into the first input data 60A, which is the image data. Through this analysis processing, the acquisition unit 22A obtains element information included in the CAD data. FIG. 16A illustrates, as an example, a case where component names a1 to a3 and component names b1 to b3 of the components as the elements included in the first input data 60A are obtained as the element information by the analysis processing by the acquisition unit 22A.

Referring back to FIG. 10, the description will be continued. In the same manner as in the first embodiment, the estimation unit 20B estimates the first estimation result from the first input data 60A acquired by the acquisition unit 22A using the machine learning model 90. Here, a description will be given on the assumption of a case where the machine learning model 90 is a model configured to output a grouping result of components, which are elements included in the input data, as the estimation result.

FIG. 16B is a schematic diagram of an example of a first estimation result 62A. In the drawings after FIG. 16B, a rectangular frame G represents the grouping result by the machine learning model 90.

For example, it is assumed that the estimation unit 20B inputs the first input data 60A illustrated in FIG. 16A to the machine learning model 90 to estimate the first estimation result 62A illustrated in FIG. 16B as an estimation result of the first input data 60A. As illustrated in FIG. 16A, the first input data 60A includes a plurality of elements. However, for example, as illustrated in FIG. 16B, there is a case where the first estimation result 62A does not include a grouping result of some elements. Therefore, it is necessary for the user to correct the first estimation result 62A.

Referring back to FIG. 10, the description will be continued. In the same manner as in the above embodiment, the search unit 20C searches the correction example DB 30 for the second taught estimation result taught for the second input data, and associated with at least one of the second input data similar to the first input data 60A and the second estimation result similar to the first estimation result 62A.

It is noted that, in this case, it is assumed that the second estimation result using the machine learning model 90, which is a model configured to output the grouping result of components, which are elements included in the input data, as the estimation result, and the second input data and the second taught estimation result corresponding to the second estimation result are registered in advance in association with each other. For example, the search unit 20C may search for similar second input data by using the similarity between the images of the first input data 60A and the second input data converted into the image data, or the similarity such as the number of components, which are elements included in the first input data 60A and the second input data, and the positions of the components.

In the same manner as in the above description, the candidate generation unit 22F generates one or more candidate estimation results different from the first estimation result 62A and the second taught estimation result based on at least one of the first estimation result 62A and the searched second taught estimation result. In the same manner as described above, the selection unit 22D selects one selection candidate among a plurality of selection candidates including the first estimation result 62A, the second taught estimation result, and the candidate estimation result as the correction target estimation result to be used for correction of the first estimation result 62A.

FIG. 16C is an explanatory diagram of an example of a correction target estimation result 68 selected by the selection unit 22D. FIG. 16C illustrates, as an example, a case where the selection unit 22D selects the second taught estimation result 64B1 among the second taught estimation results 64B included in the selection candidate 66 as the correction target estimation result 68.

FIG. 16D is a schematic diagram of an example of a first taught estimation result 64A. In the same manner as in the above embodiment, the correction unit 20E receives a correction input by the user for the correction target estimation result 68 selected by the selection unit 22D, and reflects the received correction input in the correction target estimation result 68. By this reflection processing, the correction unit 20E generates the first taught estimation result 64A taught for the first input data 60A.

As described above, in the teaching device 11 according to the present embodiment, one selection candidate 66 further selected by the selection unit 22D from the plurality of selection candidates 66 is used as the correction target estimation result 68 as compared with the above embodiment. Therefore, the user can generate the first taught estimation result with a smaller correction load as compared with the related art.

Referring back to FIG. 10, the description will be continued.

The conversion unit 22G converts a first taught estimation result generated by the correction unit 20E into element information corresponding to the first taught estimation result included in the first input data used for deriving the first taught estimation result.

For example, it is assumed that the correction unit 20E generates the first taught estimation result 64A illustrated in FIG. 16D, and the first input data used for deriving the first taught estimation result 64A is the first input data 60A illustrated in FIG. 16A.

As described above, the acquisition unit 22A analyzes the first input data 60A and acquires the one or more pieces of element information included in the first input data 60A. Specifically, the acquisition unit 22A analyzes the CAD data, which is the input data before conversion into the first input data 60A, which is the image data. Through this analysis processing, the acquisition unit 22A obtains element information included in the CAD data. FIG. 16A illustrates, as an example, a case where component names a1 to a3 and component names b1 to b3 of the components as the elements included in the first input data 60A are obtained as the element information by the analysis processing by the acquisition unit 22A.

For example, as illustrated in FIG. 16D, it is assumed that the first taught estimation result 64A represents a grouping result of Group 1 and Group 2 represented by the rectangular frame G in the drawing.

In this case, the conversion unit 22G converts each of the Group 1 and the Group 2, which are grouping results represented by the first taught estimation result 64A, into a group of component names, which is element information corresponding to each group. Specifically, for example, the conversion unit 22G converts the Group 1 into component names a1 to a3, and converts the Group 2 into component names a1 to a3. Then, the conversion unit 22G outputs the name of each group represented by the grouping result and the component name belonging to each group in association with each other.

Specifically, the conversion unit 22G outputs the name “Group1” of a group and the component names a1 to a3 belonging to the group in association with each other, and outputs the name “Group2” of a group and the component names a1 to a3 belonging to the group in association with each other.

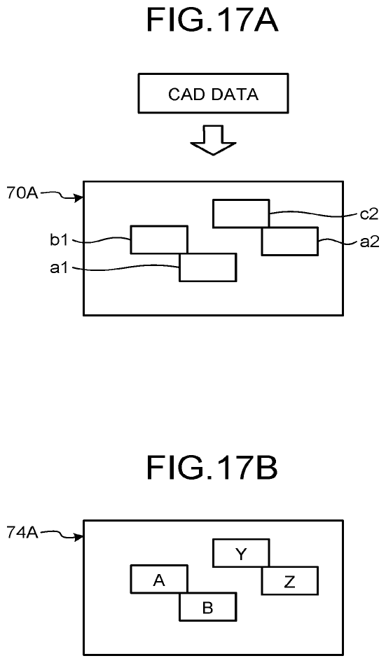

FIGS. 17A and 17B are explanatory diagrams of other examples of processing by the conversion unit 22G.

For example, a description will be given on the assumption of a case where the machine learning model 90 is a deep learning network that outputs a label indicating an attribute or the like of an element included in the input data as the estimation result. For example, it is assumed that the acquisition unit 22A generates first input data 70A, which is the image data from the CAD data illustrated in FIG. 17A. Then, the acquisition unit 22A analyzes the CAD data, which is the input data before conversion into the first input data 70A, which is the image data. An illustration is given, as an example, as to a case where the acquisition unit 22A obtains an element a1, an element a2, an element b1, and an element c1 included in the first input data 70A as element information by this analysis processing.

In addition, it is assumed that a first taught estimation result 74A illustrated in FIG. 17B is generated by performing estimation processing using the machine learning model 90 by the estimation unit 20B, search processing by the search unit 20C, candidate generation processing by the candidate generation unit 22F, selection processing by the selection unit 22D, and correction processing by the correction unit 20E in the same manner as described above.

FIG. 17B illustrates, as an example, a case where the first taught estimation result 74A represents a label A, a label B, a label Y, and a label Z, each of which is assigned to a corresponding one of the plurality of elements included in the first input data 70A.

In this case, the conversion unit 22G converts each of the label A, the label B, the label Y, and the label Z included in the estimation result represented by the first taught estimation result 74A into an element name corresponding to each label. Specifically, for example, the conversion unit 22G converts the label A into the element b1, converts the label B into the element a1, converts the label Y into the element c2, and converts the label Z into the element a2. Then, the conversion unit 22G outputs each label represented by the estimation result and the element name to which each label is assigned in association with each other.

Specifically, the conversion unit 22G outputs the label A and the element b1, the label B and the element a1, the label Y and the element c2, and the label Z and the element a2 in association with each other.

Next, a description will be given as to an example of a flow of information processing executed by the teaching device 11 according to the present embodiment.

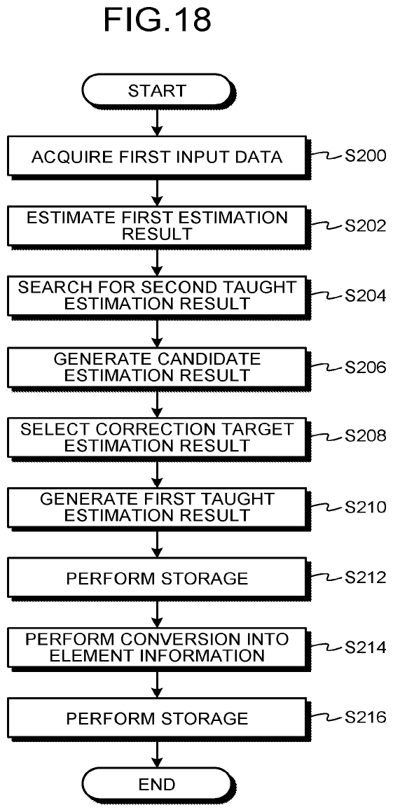

FIG. 18 is a flowchart illustrating the example of the flow of the information processing executed by the teaching device 11 according to the present embodiment. In FIG. 18, the flow of the information processing will be described assuming a case where the acquisition unit 22A acquires the first input data 50A.

The acquisition unit 22A acquires the first input data 50A (Step S200). The estimation unit 20B estimates the first estimation result 52A from the first input data acquired in Step S200 using the machine learning model (Step S202).

The search unit 20C searches for the second taught estimation result 54B associated with at least one of the second input data 50B similar to the first input data 50A acquired in Step S200 and the second estimation result similar to the first estimation result 52A estimated in Step S202 (Step S204).

The candidate generation unit 22F generates, based on at least one of the first estimation result 52A estimated in Step S202 and the second taught estimation result 54B searched in Step S204, the one or more candidate estimation results 57 different from the first estimation result 52A and the second taught estimation result 54B (Step 206).

The selection unit 22D selects one selection candidate 56 among the plurality of selection candidates 56 including the first estimation result 42A staying in Step S202, the second taught estimation result 44B searched in Step S204, and the candidate estimation result 57 generated in Step S206 as the correction target estimation result 58 used for correction of the first estimation result 52A (Step S208).

The correction unit 20E receives a correction input by the user for the correction target estimation result 58 selected in Step S208, and generates the first taught estimation result taught for the first input data the first taught estimation result being obtained by reflecting the received correction input in the correction target estimation result 58 (Step S210).

The correction unit 20E stores the first input data 50A acquired in Step S200, the first estimation result 52A estimated in Step S202, and the first taught estimation result generated in Step S210 in the correction example DB in association with each other as the second input data, the second estimation result, and the second taught estimation result (Step S212).

Next, the conversion unit 22G converts the first taught estimation result generated in Step S210 into element information corresponding to the first taught estimation result included in the first input data 50A used to derive the first taught estimation result (Step S214). Then, the conversion unit 22G stores the first input data the first taught estimation result, and the converted element information in the storage unit 12 in association with each other (Step S216). Then, this routine is ended.

As described above, the teaching device 11 according to the present embodiment further includes the candidate generation unit 22F. The candidate generation unit 22F generates the one or more candidate estimation results 57 different from the first estimation result 52A and the second taught estimation result 54B based on at least one of the first estimation result 52A and the second taught estimation result 54B. The selection unit 22D selects one selection candidate 56 among a plurality of selection candidates 56 including the first estimation result 42A, the second taught estimation result 44B, and the candidate estimation result 57 as the correction target estimation result 58 to be used for correction of the first estimation result 52A.

That is, the selection unit 22D further uses the candidate estimation result 57 as the selection candidate 56 in addition to the first estimation result 42A and the second taught estimation result 44B. Then, the selection unit 22D selects one selection candidate 56 among the plurality of selection candidates 56 as a correction target estimation result 58 used for correction of the first estimation result 52A.

As described above, in the teaching device 11 according to the present embodiment, one selection candidate 56 further selected from the plurality of selection candidates 56 is used as the correction target estimation result 58 as compared with the above embodiment. Therefore, the user can generate the first taught estimation result with a smaller correction load as compared with the related art.

Therefore, the teaching device 11 according to the present embodiment can further reduce the correction load of the output from the machine learning model 90 in addition to the effect of the teaching device 10 according to the above embodiment.

It is noted that the application target of the teaching system 1 and the teaching system 1B according to the above embodiment is not limited. For example, the teaching system 1 and the teaching system 1B are suitably applied to an environment in which person detection included in an image is performed, an environment in which vehicle detection included in an image captured by an in-vehicle camera is performed, an environment in which an image including an object is detected or classified, or the like.

Next, an example of a hardware configuration of the teaching device 10 and the teaching device 11 according to the above embodiment will be described.

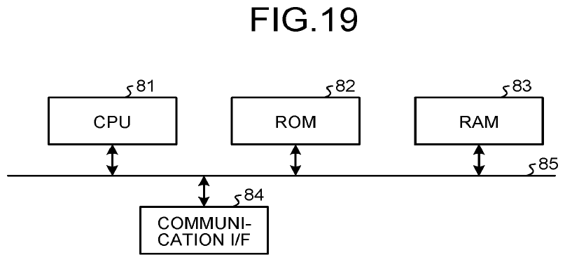

FIG. 19 is a hardware configuration diagram of an example of the teaching device 10 and the teaching device 11 according to the above embodiment.

The teaching device 10 and the teaching device 11 according to the above embodiment have a hardware configuration using a normal computer in which a central processing unit (CPU) 81, a read only memory (ROM) 82, a random access memory (RAM) 83, a communication I/F 84, and the like are connected to each other by a bus 85.

The CPU 81 is an arithmetic device that controls the teaching device 10 and the teaching device 11 according to the above embodiment. The ROM 82 stores a program and the like for implementing various kinds of processing by the CPU 81. Although the CPU is used in the description here, a graphics processing unit (GPU) may be used as the arithmetic device that controls the teaching device 10 and the teaching device 11. The RAM 83 stores data necessary for various kinds of processing by the CPU 81. The communication I/F 84 is an interface for connection to the UI unit 16 and the like to transmit and receive data.

In the teaching device 10 and the teaching device 11 according to the above embodiment, the CPU 81 reads a program from the ROM 82 onto the RAM 83 and executes the program, thereby implementing each of the functions on the computer.

It is noted that the program for executing the above-described respective pieces of processing executed by the teaching device 10 and the teaching device 11 according to the above embodiment may be stored in a hard disk drive (HDD). In addition, the program for executing the above-described respective pieces of processing executed by the teaching device 10 and the teaching device 11 according to the above embodiment may be provided by being incorporated in the ROM 82 in advance.

Furthermore, the program for executing the above-described respective pieces of processing executed by the teaching device 10 and the teaching device 11 according to the above embodiment may be stored as a file in an installable format or an executable format in a computer-readable storage medium such as a CD-ROM, a CD-R, a memory card, a digital versatile disk (DVD), or a flexible disk (FD), and the same may be provided as a computer program product. In addition, the program for executing the above-described respective pieces of processing executed by the teaching device 10 and the teaching device 11 according to the above embodiment may be stored on a computer connected to a network such as the Internet, and the same may be provided by being downloaded via the network. In addition, the program for executing the above-described respective pieces of processing executed by the teaching device 10 and the teaching device 11 according to the above embodiment may be provided or distributed via a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A teaching device comprising:
an acquisition unit configured to acquire first input data;
an estimation unit configured to estimate a first estimation result from the first input data, using a machine learning model;
a search unit configured to search for a second taught estimation result taught for second input data, the second taught estimation result being associated with at least one of the second input data similar to the first input data, and a second estimation result similar to the first estimation result and estimated from the second input data, using the machine learning model; and
a selection unit configured to select one selection candidate among a plurality of selection candidates including the first estimation result and the second taught estimation result, as a correction target estimation result to be used for correction of the first estimation result.

2. The device according to claim 1, wherein
the selection unit is configured to
output a plurality of selection candidates to an output unit, and select, as the correction target estimation result, the one selection candidate among the plurality of output selection candidates, a selection input by a user being received for the one selection candidate.

3. The device according to claim 2, wherein
the output unit is a display unit.

4. The device according to claim 1, wherein
the selection unit is configured to
select the one selection candidate among the plurality of selection candidates, as the correction target estimation result, the one selection candidate satisfying a predetermined condition.

5. The device according to claim 1, further comprising
a correction unit configured to receive a correction input by a user for the correction target estimation result, and generate a first taught estimation result taught for the first input data, the first taught estimation result being obtained by reflecting the received correction input in the correction target estimation result.

6. The device according to claim 1, further comprising
a candidate generation unit configured to generate, based on at least one of the first estimation result and the second taught estimation result, a candidate estimation result different from the first estimation result and the second taught estimation result, wherein
the selection unit is configured to
select, as the correction target estimation result, the one selection candidate among the plurality of selection candidates including the first estimation result, the second taught estimation result, and the candidate estimation result.

7. The device according to claim 6, wherein
the candidate generation unit is configured to
generate one or more candidate estimation results including one or more local regions according to similarity between each of first local regions which are the one or more local regions included in the first estimation result for the first input data, and each of second local regions which are one or more local regions included in the second taught estimation result.

8. The device according to claim 1, wherein
the first input data and the second input data are
image data, CAD data, or sound data.

9. The device according to claim 8, wherein
the acquisition unit is configured to
convert the CAD data or the sound data into image data and uses it as the first input data and the second input data.

10. The device according to claim 5, further comprising
a conversion unit configured to convert the first taught estimation result into element information corresponding to the first taught estimation result included in the first input data used to derive the first taught estimation result.

11. A teaching method comprising:
acquiring first input data;
estimating a first estimation result from the first input data, using a machine learning model;
searching for a second taught estimation result taught for second input data, the second taught estimation result being associated with at least one of the second input data similar to the first input data, and a second estimation result similar to the first estimation result and estimated from the second input data, using the machine learning model; and
selecting one selection candidate among a plurality of selection candidates including the first estimation result and the second taught estimation result, as a correction target estimation result to be used for correction of the first estimation result.

12. A computer program product comprising a computer-readable medium including programmed instructions, the instructions causing a computer to execute:
acquiring first input data;
estimating a first estimation result from the first input data, using a machine learning model;
searching for a second taught estimation result taught for second input data, the second taught estimation result being associated with at least one of the second input data similar to the first input data, and a second estimation result similar to the first estimation result and estimated from the second input data, using the machine learning model; and
selecting one selection candidate among a plurality of selection candidates including the first estimation result and the second taught estimation result, as a correction target estimation result to be used for correction of the first estimation result.
